(19) United States
(12) Patent Application Publication
(10) Pub. No.: US 2026/0153627 A1
(43) Pub. Date: Jun. 4, 2026

(54) LIDAR SYSTEM

(71) Applicant: Aurora Operations, Inc., Pittsburgh, PA (US)

(72) Inventors: Nicholas Anthony Buoniconti, IV, Palo Alto, CA (US); Yonggang Ha, Palo Alto, CA (US); Zhongjie Li, Palo Alto, CA (US); Cal Alden Smith, Palo Alto, CA (US)

(73) Assignee: Aurora Operations, Inc., Pittsburgh, PA (US)

(21) Appl. No.: 18/927,284

(22) Filed: Oct. 25, 2024

Related U.S. Application Data
(63) Continuation of application No. 17/592,286, filed on Feb. 3, 2022, now Pat. No. 12,130,363.

(51) Int. Cl. G01S 17/931; G01S 7/481; G01S 17/42

(52) U.S. Cl. CPC G01S 17/931; G01S 7/4817; G01S 17/42

(57) ABSTRACT

A light detection and ranging (LIDAR) system includes a laser source and a polygon scanner. The laser source is configured to generate a first beam. The polygon scanner includes a frame and a plurality of mirrors coupled to the frame, each mirror comprising a glass material.

### CROSS-REFERENCE TO RELATED APPLICATIONS

The present application is a continuation of U.S. patent application Ser. No. 17/592,286, filed Feb. 3, 2022. The entire disclosure of U.S. patent application Ser. No. 17/592,286 is incorporated herein by reference.

### BACKGROUND

Optical detection of range using lasers, often referenced by a mnemonic, LIDAR (for “light detection and ranging”), also sometimes referred to as “laser RADAR,” is used for a variety of applications, including imaging and collision avoidance. LIDAR provides finer scale range resolution with smaller beam sizes than conventional microwave ranging systems, such as radio-wave detection and ranging (RADAR).

### SUMMARY

At least one aspect relates to a light detection and ranging (LIDAR) system. The LIDAR system includes a laser source configured to generate a beam and a polygon scanner. The polygon scanner includes a frame and a plurality of mirrors coupled to the frame, each mirror including a glass material.

At least one aspect relates to an autonomous vehicle control system. The autonomous vehicle control system includes a laser source, a polygon scanner, and one or more processors. The laser source is configured to generate a first beam. The polygon scanner includes a frame and a plurality of mirrors coupled to the frame, each mirror comprising a glass material, the polygon scanner configured to reflect the first beam as a second beam. The one or more processors are configured to determine at least one of a range to an object or a velocity of the object using a third beam received from at least one of reflection or scattering of the second beam by the object, control operation of an autonomous vehicle responsive to the at least one of the range or the velocity.

At least one aspect relates to an autonomous vehicle. The autonomous vehicle includes a LIDAR system including a laser source configured to generate a first beam and a polygon scanner that includes a frame and a plurality of mirrors coupled to the frame, each mirror comprising a glass material. The autonomous vehicle includes a steering system, a braking system, and a vehicle controller including one or more processors configured to determine at least one of a range to an object or a velocity of the object using a third beam received from at least one of reflection or scattering of the second beam by the object, and control operation of the at least one of the steering system and the braking system responsive to the at least one of the range or the velocity.

Those skilled in the art will appreciate that the summary is illustrative only and is not intended to be in any way limiting. Any of the features described herein may be used with any other features, and any subset of such features can be used in combination according to various embodiments. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Implementations are illustrated by way of example, and not by way of limitation, in the figures of the accompanying drawings in which like reference numerals refer to similar elements and in which:

FIG. 1A is a block diagram of an example of a system environment for autonomous vehicles;

FIG. 1B is a block diagram of an example of a system environment for autonomous commercial trucking vehicles;

FIG. 1C is a block diagram of an example of a system environment for autonomous commercial trucking vehicles;

FIG. 1D is a block diagram of an example of a system environment for autonomous commercial trucking vehicles;

FIG. 2 is a block diagram of an example of a LIDAR system;

FIG. 3 is a perspective view of an example of a polygon scanner for use in a LIDAR system.

FIG. 4 is an exploded view of the polygon scanner of FIG. 3.

FIG. 5 is a top exploded view of the polygon scanner of FIG. 3.

FIG. 6 is a chart of an example of a thermal loading test of a polygon scanner.

FIG. 7 is a chart of an example of a bonding test of a polygon scanner.

FIG. 8 is a chart of an example of a mirror displacement test of a polygon scanner.

### DETAILED DESCRIPTION

A LIDAR system can generate and transmit a light beam that an object can reflect or otherwise scatter as a return beam corresponding to the transmitted beam. The LIDAR system can receive the return beam, and process the return beam or characteristics thereof to determine parameters regarding the object such as range and velocity. The LIDAR system can apply various frequency or phase modulations to the transmitted beam, which can facilitate relating the return beam to the transmitted beam in order to determine the parameters regarding the object.

The LIDAR system can include a laser source and a polygon scanner. The laser source is configured to generate a first beam. The polygon scanner includes a frame and a plurality of mirrors coupled to the frame, each mirror comprising a glass material. The mirrors can reflect the first beam to output a second beam, which can be scanned over a field of view to be reflected or otherwise scattered by an object as a third beam, which can be used to determine range, velocity, and Doppler information regarding the object, such as for controlling operation of an autonomous vehicle.

Systems and methods in accordance with the present disclosure can implement LIDAR systems in which a polygon scanner is assembled by having multiple facets of polished glass mirrors that are attached to the frame, as compared to polygon scanners in which the scanner is formed by machining (e.g., computer numerical control (CNC) processes), such as by being made from diamond turned aluminum. By using polished glass mirrors for the facets, the surfaces of the facets can be made more flat and less rough, which can enable optical improvements such as higher reflectivity, lower scattering, and/or more particular beam shapes that are desirable for autonomous vehicles (e.g., beam shape having a lesser degree of variation from an ideal Gaussian beam). For example, making the facets more flat and/or less rough can reduce the likelihood of reflections or scattering occurring within surface of the facets themselves (such reflections or scattering can have Doppler shifts or otherwise contribute noise to the signal processing). In addition, the assembled polygon scanner can have reduced weight and/or inertia relative to polygon scanners made from solid metal blocks, which can improve reliability of the motor that rotates the polygon scanner and allow for greater flexibility in the form factor of the facets (e.g., to allow for larger facets or facets of various shapes, such as concave or convex facets). The assembled polygon scanner can be manufactured with a less complex, more scalable process. However, the advantages of the assembled polygon scanner described above are not limited to autonomous vehicles. They can be advantageous for any type of vehicles equipped with LIDAR sensors.

### 1. System Environments for Autonomous Vehicles

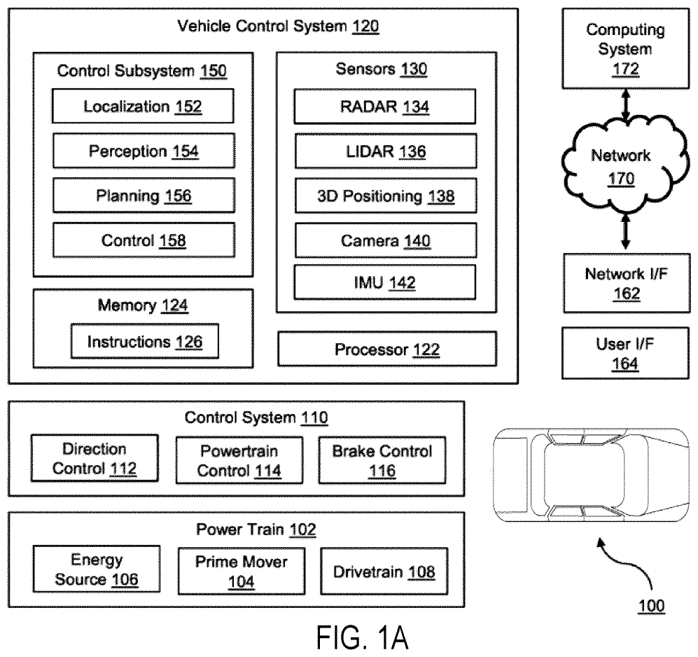

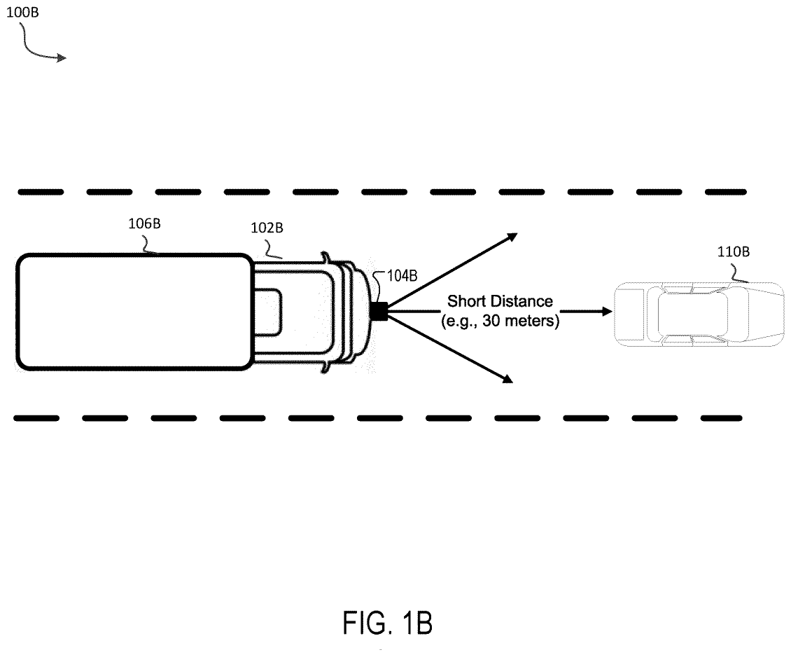

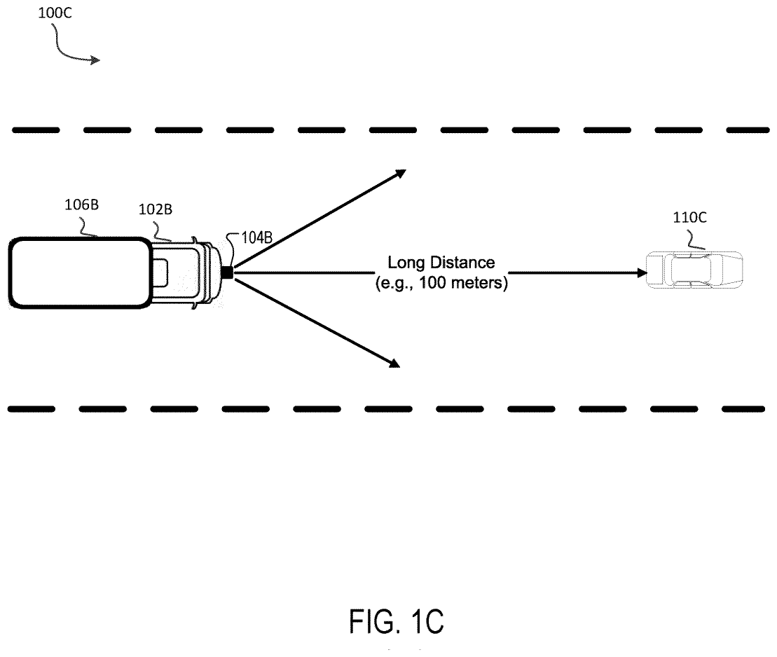

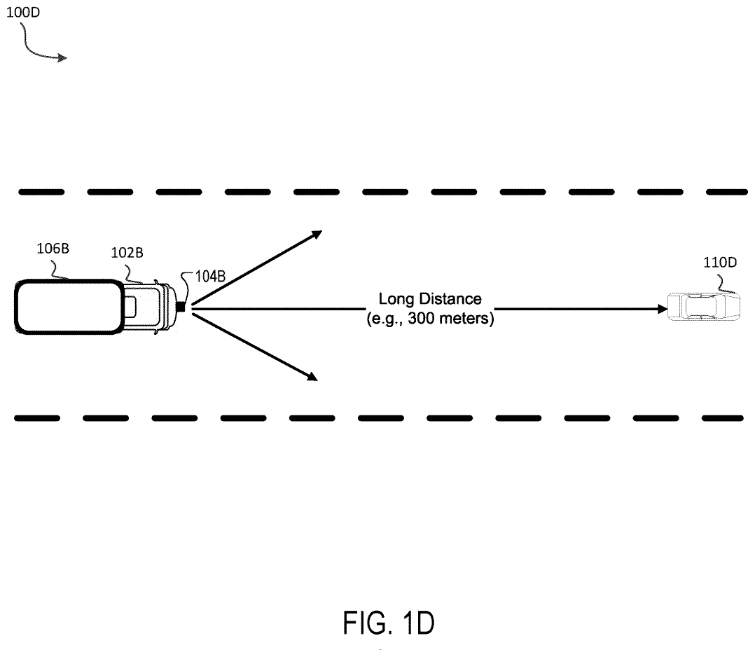

FIG. 1A is a block diagram illustrating an example of a system environment for autonomous vehicles according to some implementations. FIG. 1A depicts an example autonomous vehicle 100 within which the various techniques disclosed herein may be implemented. The vehicle 100, for example, may include a powertrain 102 including a prime mover 104 powered by an energy source 106 and capable of providing power to a drivetrain 108, as well as a control system 110 including a direction control 112, a powertrain control 114, and a brake control 116. The vehicle 100 may be implemented as any number of different types of vehicles, including vehicles capable of transporting people and/or cargo, and capable of traveling in various environments. The aforementioned components 102-116 can vary widely based upon the type of vehicle within which these components are utilized, such as a wheeled land vehicle such as a car, van, truck, or bus. The prime mover 104 may include one or more electric motors and/or an internal combustion engine (among others). The energy source may include, for example, a fuel system (e.g., providing gasoline, diesel, hydrogen, etc.), a battery system, solar panels or other renewable energy source, and/or a fuel cell system. The drivetrain 108 can include wheels and/or tires along with a transmission and/or any other mechanical drive components to convert the output of the prime mover 104 into vehicular motion, as well as one or more brakes configured to controllably stop or slow the vehicle 100 and direction or steering components suitable for controlling the trajectory of the vehicle 100 (e.g., a rack and pinion steering linkage enabling one or more wheels of the vehicle 100 to pivot about a generally vertical axis to vary an angle of the rotational planes of the wheels relative to the longitudinal axis of the vehicle). In some implementations, combinations of powertrains and energy sources may be used (e.g., in the case of electric/gas hybrid vehicles), and in some instances multiple electric motors (e.g., dedicated to individual wheels or axles) may be used as a prime mover.

The direction control 112 may include one or more actuators and/or sensors for controlling and receiving feedback from the direction or steering components to enable the vehicle 100 to follow a desired trajectory. The powertrain control 114 may be configured to control the output of the powertrain 102, e.g., to control the output power of the prime mover 104, to control a gear of a transmission in the drivetrain 108, etc., thereby controlling a speed and/or direction of the vehicle 100. The brake control 116 may be configured to control one or more brakes that slow or stop vehicle 100, e.g., disk or drum brakes coupled to the wheels of the vehicle.

Other vehicle types, including but not limited to off-road vehicles, all-terrain or tracked vehicles, construction equipment, may utilize different powertrains, drivetrains, energy sources, direction controls, powertrain controls and brake controls. Moreover, in some implementations, some of the components can be combined, e.g., where directional control of a vehicle is primarily handled by varying an output of one or more prime movers.

Various levels of autonomous control over the vehicle 100 can be implemented in a vehicle control system 120, which may include one or more processors 122 and one or more memories 124, with each processor 122 configured to execute program code instructions 126 stored in a memory 124. The processors(s) can include, for example, graphics processing unit(s) (“GPU(s)”)) and/or central processing unit(s) (“CPU(s)”).

Sensors 130 may include various sensors suitable for collecting information from a vehicle's surrounding environment for use in controlling the operation of the vehicle. For example, sensors 130 can include radar sensor 134, LIDAR (Light Detection and Ranging) sensor 136, a 3D positioning sensors 138, e.g., any of an accelerometer, a gyroscope, a magnetometer, or a satellite navigation system such as GPS (Global Positioning System), GLONASS (Globalnaya Navigazionnaya Sputnikovaya Sistema, or Global Navigation Satellite System), BeiDou Navigation Satellite System (BDS), Galileo, Compass, etc. The 3D positioning sensors 138 can be used to determine the location of the vehicle on the Earth using satellite signals. The sensors 130 can include a camera 140 and/or an IMU (inertial measurement unit) 142. The camera 140 can be a monographic or stereographic camera and can record still and/or video images. The IMU 142 can include multiple gyroscopes and accelerometers capable of detecting linear and rotational motion of the vehicle in three directions. One or more encoders (not illustrated), such as wheel encoders may be used to monitor the rotation of one or more wheels of vehicle 100. Each sensor 130 can output sensor data at various data rates, which may be different than the data rates of other sensors 130.

The outputs of sensors 130 may be provided to a set of control subsystems 150, including a localization subsystem 152, a planning subsystem 156, a perception subsystem 154, and a control subsystem 158. The localization subsystem 152 can perform functions such as precisely determining the location and orientation (also sometimes referred to as “pose”) of the vehicle 100 within its surrounding environment, and generally within some frame of reference. The location of an autonomous vehicle can be compared with the location of an additional vehicle in the same environment as part of generating labeled autonomous vehicle data. The perception subsystem 154 can perform functions such as detecting, tracking, determining, and/or identifying objects within the environment surrounding vehicle 100. A machine learning model in accordance with some implementations can be utilized in tracking objects. The planning subsystem 156 can perform functions such as planning a trajectory for vehicle 100 over some timeframe given a desired destination as well as the static and moving objects within the environment. A machine learning model in accordance with some implementations can be utilized in planning a vehicle trajectory. The control subsystem 158 can perform functions such as generating suitable control signals for controlling the various controls in the vehicle control system 120 in order to implement the planned trajectory of the vehicle 100. A machine learning model can be utilized to generate one or more signals to control an autonomous vehicle to implement the planned trajectory.

Multiple sensors of types illustrated in FIG. 1A can be used for redundancy and/or to cover different regions around a vehicle, and other types of sensors may be used. Various types and/or combinations of control subsystems may be used. Some or all of the functionality of a subsystem 152-158 may be implemented with program code instructions 126 resident in one or more memories 124 and executed by one or more processors 122, and these subsystems 152-158 may in some instances be implemented using the same processor(s) and/or memory. Subsystems may be implemented at least in part using various dedicated circuit logic, various processors, various field programmable gate arrays (“FPGA”), various application-specific integrated circuits (“ASIC”), various real time controllers, and the like, as noted above, multiple subsystems may utilize circuitry, processors, sensors, and/or other components. Further, the various components in the vehicle control system 120 may be networked in various manners.

In some implementations, the vehicle 100 may also include a secondary vehicle control system (not illustrated), which may be used as a redundant or backup control system for the vehicle 100. In some implementations, the secondary vehicle control system may be capable of fully operating the autonomous vehicle 100 in the event of an adverse event in the vehicle control system 120, while in other implementations, the secondary vehicle control system may only have limited functionality, e.g., to perform a controlled stop of the vehicle 100 in response to an adverse event detected in the primary vehicle control system 120. In still other implementations, the secondary vehicle control system may be omitted.

Various architectures, including various combinations of software, hardware, circuit logic, sensors, and networks, may be used to implement the various components illustrated in FIG. 1A. Each processor may be implemented, for example, as a microprocessor and each memory may represent the random access memory (“RAM”) devices comprising a main storage, as well as any supplemental levels of memory, e.g., cache memories, non-volatile or backup memories (e.g., programmable or flash memories), read-only memories, etc. In addition, each memory may be considered to include memory storage physically located elsewhere in the vehicle 100, e.g., any cache memory in a processor, as well as any storage capacity used as a virtual memory, e.g., as stored on a mass storage device or another computer controller. One or more processors illustrated in FIG. 1A, or entirely separate processors, may be used to implement additional functionality in the vehicle 100 outside of the purposes of autonomous control, e.g., to control entertainment systems, to operate doors, lights, convenience features, etc.

In addition, for additional storage, the vehicle 100 may include one or more mass storage devices, e.g., a removable disk drive, a hard disk drive, a direct access storage device (“DASD”), an optical drive (e.g., a CD drive, a DVD drive, etc.), a solid state storage drive (“SSD”), network attached storage, a storage area network, and/or a tape drive, among others.

Furthermore, the vehicle 100 may include a user interface 164 to enable vehicle 100 to receive a number of inputs from and generate outputs for a user or operator, e.g., one or more displays, touchscreens, voice and/or gesture interfaces, buttons and other tactile controls, etc. Otherwise, user input may be received via another computer or electronic device, e.g., via an app on a mobile device or via a web interface.

Moreover, the vehicle 100 may include one or more network interfaces, e.g., network interface 162, suitable for communicating with one or more networks 170 (e.g., a Local Area Network (“LAN”), a wide area network (“WAN”), a wireless network, and/or the Internet, among others) to permit the communication of information with other computers and electronic device, including, for example, a central service, such as a cloud service, from which the vehicle 100 receives environmental and other data for use in autonomous control thereof. Data collected by the one or more sensors 130 can be uploaded to a computing system 172 via the network 170 for additional processing. In some implementations, a time stamp can be added to each instance of vehicle data prior to uploading.

Each processor illustrated in FIG. 1A, as well as various additional controllers and subsystems disclosed herein, generally operates under the control of an operating system and executes or otherwise relies upon various computer software applications, components, programs, objects, modules, data structures, etc., as will be described in greater detail below. Moreover, various applications, components, programs, objects, modules, etc. may also execute on one or more processors in another computer coupled to vehicle 100 via network 170, e.g., in a distributed, cloud-based, or client-server computing environment, whereby the processing required to implement the functions of a computer program may be allocated to multiple computers and/or services over a network.

In general, the routines executed to implement the various implementations described herein, whether implemented as part of an operating system or a specific application, component, program, object, module or sequence of instructions, or even a subset thereof, will be referred to herein as “program code”. Program code can include one or more instructions that are resident at various times in various memory and storage devices, and that, when read and executed by one or more processors, perform the steps necessary to execute steps or elements embodying the various aspects of the present disclosure. Moreover, while implementations have and hereinafter will be described in the context of fully functioning computers and systems, it will be appreciated that the various implementations described herein are capable of being distributed as a program product in a variety of forms, and that implementations can be implemented regardless of the particular type of computer readable media used to actually carry out the distribution.

Examples of computer readable media include tangible, non-transitory media such as volatile and non-volatile memory devices, floppy and other removable disks, solid state drives, hard disk drives, magnetic tape, and optical disks (e.g., CD-ROMs, DVDs, etc.) among others.

In addition, various program code described hereinafter may be identified based upon the application within which it is implemented in a specific implementation. Any particular program nomenclature that follows is used merely for convenience, and thus the present disclosure should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), the present disclosure is not limited to the specific organization and allocation of program functionality described herein.

### 2. Lidar for Automotive Applications

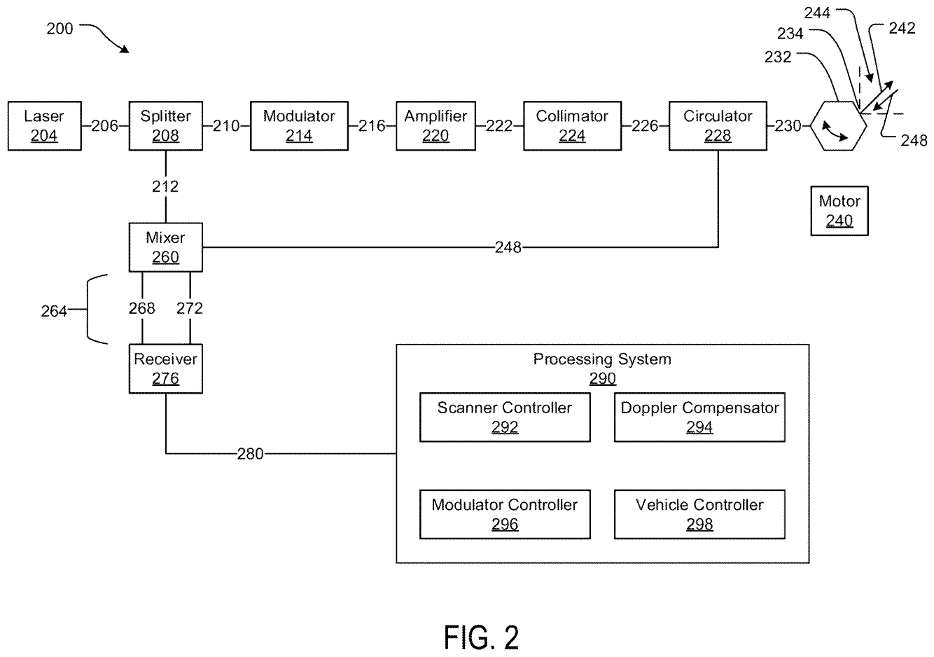

A truck can include a LIDAR system (e.g., vehicle control system 120 in FIG. 1A, LIDAR system 200 in FIG. 2, among others described herein). In some implementations, the LIDAR system can use frequency modulation to encode an optical signal and scatter the encoded optical signal into free-space using optics. By detecting the frequency differences between the encoded optical signal and a returned signal reflected back from an object, the frequency modulated (FM) LIDAR system can determine the location of the object and/or precisely measure the velocity of the object using the Doppler effect. In some implementations, an FM LIDAR system may use a continuous wave (referred to as, “FMCW LIDAR”) or a quasi-continuous wave (referred to as, “FMQW LIDAR”). In some implementations, the LIDAR system can use phase modulation (PM) to encode an optical signal and scatters the encoded optical signal into free-space using optics.

In some instances, an object (e.g., a pedestrian wearing dark clothing) may have a low reflectivity, in that it only reflects back to the sensors (e.g., sensors 130 in FIG. 1A) of the FM or PM LIDAR system a low amount (e.g., 10% or less) of the light that hit the object. In other instances, an object (e.g., a shiny road sign) may have a high reflectivity (e.g., above 10%), in that it reflects back to the sensors of the FM LIDAR system a high amount of the light that hit the object.

Regardless of the object's reflectivity, an FM LIDAR system may be able to detect (e.g., classify, recognize, discover, etc.) the object at greater distances (e.g., 2×) than a conventional LIDAR system. For example, an FM LIDAR system may detect a low reflectively object beyond 300 meters, and a high reflectivity object beyond 400 meters.

To achieve such improvements in detection capability, the FM LIDAR system may use sensors (e.g., sensors 130 in FIG. 1A). In some implementations, these sensors can be single photon sensitive, meaning that they can detect the smallest amount of light possible. While an FM LIDAR system may, in some applications, use infrared wavelengths (e.g., 950 nm, 1550 nm, etc.), it is not limited to the infrared wavelength range (e.g., near infrared: 800 nm-1500 nm; middle infrared: 1500 nm-5600 nm; and far infrared: 5600 nm-1,000,000 nm). By operating the FM or PM LIDAR system in infrared wavelengths, the FM or PM LIDAR system can broadcast stronger light pulses or light beams than conventional LIDAR systems.

Thus, by detecting an object at greater distances, an FM LIDAR system may have more time to react to unexpected obstacles. Indeed, even a few milliseconds of extra time could improve response time and comfort, especially with heavy vehicles (e.g., commercial trucking vehicles) that are driving at highway speeds.

The FM LIDAR system can provide accurate velocity for each data point instantaneously. In some implementations, a velocity measurement is accomplished using the Doppler effect which shifts frequency of the light received from the object based at least one of the velocity in the radial direction (e.g., the direction vector between the object detected and the sensor) or the frequency of the laser signal. For example, for velocities encountered in on-road situations where the velocity is less than 100 meters per second (m/s), this shift at a wavelength of 1550 nanometers (nm) amounts to the frequency shift that is less than 130 megahertz (MHz). This frequency shift is small such that it is difficult to detect directly in the optical domain. However, by using coherent detection in FMCW, PMCW, or FMQW LIDAR systems, the signal can be converted to the RF domain such that the frequency shift can be calculated using various signal processing techniques. This enables the autonomous vehicle control system to process incoming data faster.

Instantaneous velocity calculation also makes it easier for the FM LIDAR system to determine distant or sparse data points as objects and/or track how those objects are moving over time. For example, an FM LIDAR sensor (e.g., sensors 130 in FIG. 1A) may only receive a few returns (e.g., hits) on an object that is 300 m away, but if those return give a velocity value of interest (e.g., moving towards the vehicle at >70 mph), then the FM LIDAR system and/or the autonomous vehicle control system may determine respective weights to probabilities associated with the objects.

Faster identification and/or tracking of the FM LIDAR system gives an autonomous vehicle control system more time to maneuver a vehicle. A better understanding of how fast objects are moving also allows the autonomous vehicle control system to plan a better reaction.

The FM LIDAR system can have less static compared to conventional LIDAR systems. That is, the conventional LIDAR systems that are designed to be more light-sensitive typically perform poorly in bright sunlight. These systems also tend to suffer from crosstalk (e.g., when sensors get confused by each other's light pulses or light beams) and from self-interference (e.g., when a sensor gets confused by its own previous light pulse or light beam). To overcome these disadvantages, vehicles using the conventional LIDAR systems often need extra hardware, complex software, and/or more computational power to manage this “noise.”

In contrast, FM LIDAR systems do not suffer from these types of issues because each sensor is specially designed to respond only to its own light characteristics (e.g., light beams, light waves, light pulses). If the returning light does not match the timing, frequency, and/or wavelength of what was originally transmitted, then the FM sensor can filter (e.g., remove, ignore, etc.) out that data point. As such, FM LIDAR systems produce (e.g., generates, derives, etc.) more accurate data with less hardware or software requirements, enabling smoother driving.

The FM LIDAR system can be easier to scale than conventional LIDAR systems. As more self-driving vehicles (e.g., cars, commercial trucks, etc.) show up on the road, those powered by an FM LIDAR system likely will not have to contend with interference issues from sensor crosstalk. Furthermore, an FM LIDAR system uses less optical peak power than conventional LIDAR sensors. As such, some or all of the optical components for an FM LIDAR can be produced on a single chip, which produces its own benefits, as discussed herein.

### 2.1 Commercial Trucking

FIG. 1B is a block diagram illustrating an example of a system environment for autonomous commercial trucking vehicles, according to some implementations. The environment 100B includes a commercial truck 102B for hauling cargo 106B. In some implementations, the commercial truck 102B may include vehicles configured to long-haul freight transport, regional freight transport, intermodal freight transport (i.e., in which a road-based vehicle is used as one of multiple modes of transportation to move freight), and/or any other road-based freight transport applications. In some implementations, the commercial truck 102B may be a flatbed truck, a refrigerated truck (e.g., a reefer truck), a vented van (e.g., dry van), a moving truck, etc. In some implementations, the cargo 106B may be goods and/or produce. In some implementations, the commercial truck 102B may include a trailer to carry the cargo 106B, such as a flatbed trailer, a lowboy trailer, a step deck trailer, an extendable flatbed trailer, a sidekit trailer, etc.

The environment 100B includes an object 110B (shown in FIG. 1B as another vehicle) that is within a distance range that is equal to or less than 30 meters from the truck.

The commercial truck 102B may include a LIDAR system 104B (e.g., an FM LIDAR system, vehicle control system 120 in FIG. 1A, LIDAR system 200 in FIG. 2) for determining a distance to the object 110B and/or measuring the velocity of the object 110B. Although FIG. 1B shows that one LIDAR system 104B is mounted on the front of the commercial truck 102B, the number of LIDAR system and the mounting area of the LIDAR system on the commercial truck are not limited to a particular number or a particular area. The commercial truck 102B may include any number of LIDAR systems 104B (or components thereof, such as sensors, modulators, coherent signal generators, etc.) that are mounted onto any area (e.g., front, back, side, top, bottom, underneath, and/or bottom) of the commercial truck 102B to facilitate the detection of an object in any free-space relative to the commercial truck 102B.

As shown, the LIDAR system 104B in environment 100B may be configured to detect an object (e.g., another vehicle, a bicycle, a tree, street signs, potholes, etc.) at short distances (e.g., 30 meters or less) from the commercial truck 102B.

FIG. 1C is a block diagram illustrating an example of a system environment for autonomous commercial trucking vehicles, according to some implementations. The environment 100C includes the same components (e.g., commercial truck 102B, cargo 106B, LIDAR system 104B, etc.) that are included in environment 100B.

The environment 100C includes an object 110C (shown in FIG. 1C as another vehicle) that is within a distance range that is (i) more than 30 meters and (ii) equal to or less than 150 meters from the commercial truck 102B. As shown, the LIDAR system 104B in environment 100C may be configured to detect an object (e.g., another vehicle, a bicycle, a tree, street signs, potholes, etc.) at a distance (e.g., 100 meters) from the commercial truck 102B.

FIG. 1D is a block diagram illustrating an example of a system environment for autonomous commercial trucking vehicles, according to some implementations. The environment 100D includes the same components (e.g., commercial truck 102B, cargo 106B, LIDAR system 104B, etc.) that are included in environment 100B.

The environment 100D includes an object 110D (shown in FIG. 1D as another vehicle) that is within a distance range that is more than 150 meters from the commercial truck 102B. As shown, the LIDAR system 104B in environment 100D may be configured to detect an object (e.g., another vehicle, a bicycle, a tree, street signs, potholes, etc.) at a distance (e.g., 300 meters) from the commercial truck 102B.

In commercial trucking applications, it is important to effectively detect objects at all ranges due to the increased weight and, accordingly, longer stopping distance required for such vehicles. FM LIDAR systems (e.g., FMCW and/or FMQW systems) or PM LIDAR systems are well-suited for commercial trucking applications due to the advantages described above. As a result, commercial trucks equipped with such systems may have an enhanced ability to move both people and goods across short or long distances. In various implementations, such FM or PM LIDAR systems can be used in semi-autonomous applications, in which the commercial truck has a driver and some functions of the commercial truck are autonomously operated using the FM or PM LIDAR system, or fully autonomous applications, in which the commercial truck is operated entirely by the FM or LIDAR system, alone or in combination with other vehicle systems.

### 3. Lidar Systems

FIG. 2 depicts an example of a LIDAR system 200. The LIDAR system 200 can be used to determine parameters regarding objects, such as range and velocity, and output the parameters to a remote system. For example, the LIDAR system 200 can output the parameters for use by a vehicle controller that can control operation of a vehicle responsive to the received parameters (e.g., vehicle controller 298) or a display that can present a representation of the parameters. The LIDAR system 200 can be a coherent detection system. The LIDAR system 200 can be used to implement various features and components of the systems described with reference to FIGS. 1A-1D. The LIDAR system 200 can include components for performing various detection approaches, such as to be operated as an amplitude modular LIDAR system or a coherent LIDAR system. The LIDAR system 200 can be used to perform time of flight range determination. In some implementations, various components or combinations of components of the LIDAR system 200, such as laser source 204 and modulator 214, can be in a same housing, provided in a same circuit board or other electronic component, or otherwise integrated. In some implementations, various components or combinations of components of the LIDAR system 200 can be provided as separate components, such as by using optical couplings (e.g., optical fibers) for components that generate and/or receive optical signals, such as light beams, or wired or wireless electronic connections for components that generate and/or receive electrical (e.g., data) signals.

The LIDAR system 200 can include a laser source 204 that generates and emits a beam 206, such as a carrier wave light beam. A splitter 208 can split the beam 206 into a beam 210 and a reference beam 212 (e.g., reference signal). In some implementations, any suitable optical, electronic, or opto-electronic elements can be used to provide the beam 210 and the reference beam 212 from the laser 204 to other elements.

A modulator 214 can modulate one or more properties of the input beam 210 to generate a beam 216 (e.g., target beam). In some implementations, the modulator 214 can modulate a frequency of the input beam 210 (e.g., optical frequency corresponding to optical wavelength, where c=λν, where c is the speed of light, λ is the wavelength, and ν is the frequency). For example, the modulator 214 can modulate a frequency of the input beam 210 linearly such that a frequency of the beam 216 increases or decreases linearly over time. As another example, the modulator 214 can modulate a frequency of the input beam 210 non-linearly (e.g., exponentially). In some implementations, the modulator 214 can modulate a phase of the input beam 210 to generate the beam 216. However, the modulation techniques are not limited to the frequency modulation and the phase modulation. Any suitable modulation techniques can be used to modulate one or more properties of a beam. Returning to FIG. 2, the modulator 214 can modulate the beam 210 subsequent to splitting of the beam 206 by the splitter 208, such that the reference beam 212 is unmodulated, or the modulator 214 can modulate the beam 206 and provide a modulated beam to the splitter 208 for the splitter 208 to split into a target beam and a reference beam.

The beam 216, which is used for outputting a transmitted signal, can have most of the energy of the beam 206 outputted by the laser source 204, while the reference beam 212 can have significantly less energy, yet sufficient energy to enable mixing with a return beam 248 (e.g., returned light) scattered from an object. The reference beam 212 can be used as a local oscillator (LO) signal. The reference beam 212 passes through a reference path and can be provided to a mixer 260. An amplifier 220 can amplify the beam 216 to output a beam 222, which a collimator 224 can collimate to output a beam 226.

As depicted in FIG. 2, a circulator 228 can be between the collimator 224 and optics 232 to receive the beam 226 and output a beam 230 to the optics 232. The circulator 228 can be between the laser source 204 and the collimator 224. The circulator 228 can receive return beam 248 from the optics 232 and provide the return beam 248 to the mixer 260. The optics 232 can be scanning optics, such as one or more polygon reflectors or deflectors to adjust the angle of received beams relative to outputted beams based on the orientation of outer surfaces (e.g., facets) of the optics relative to the received beam, or solid-state components (e.g., phased arrays, electro-optic crystals) configured to modify the direction of received light.

The optics 232 can define a field of view 244 that corresponds to angles scanned (e.g., swept) by the beam 242 (e.g., a transmitted beam). For example, the beam 242 can be scanned in the particular plane, such as an azimuth plane or elevation plane (e.g., relative to an object to which the LIDAR system 200 is coupled, such as an autonomous vehicle). The optics 232 can be oriented so that the field of view 244 sweeps an azimuthal plane relative to the optics 232.

At least one motor 240 can be coupled with the optics 232 to control at least one of a position or an orientation of the optics 232 relative to the beam 230. For example, where the optics 232 include a reflector or deflector, the motor 240 can rotate the optics 232 so that surfaces of the optics 232 at which the beam 230 is received vary in angle or orientation relative to the beam 230, causing the beam 242 to be varied in angle or direction as the beam 242 is outputted from the optics 232.

The beam 242 can be outputted from the optics 232 and reflected or otherwise scattered by an object (not shown) as a return beam 248 (e.g., return signal). The return beam 248 can be received on a reception path, which can include the circulator 228, and provided to the mixer 260.

The mixer 260 can be an optical hybrid, such as a 90 degree optical hybrid. The mixer 260 can receive the reference beam 212 and the return beam 248, and mix the reference beam 212 and the return beam 248 to output a signal 264 responsive to the reference beam 212 and the return beam 248. The signal 264 can include an in-phase (I) component 268 and a quadrature (Q) component 272.

The LIDAR system 200 can include a receiver 276 that receives the signal 264 from the mixer 260. The receiver 276 can generate a signal 280 responsive to the signal 264, which can be an electronic (e.g., radio frequency) signal. The receiver 276 can include one or more photodetectors that output the signal 280 responsive to the signal 264.

The LIDAR system 200 can include a processing system 290, which can be implemented using features of the vehicle control system 120 described with reference to FIG. 1A. The processing system 290 can process data received regarding the return beam 248, such as the signal 280, to determine parameters regarding the object such as range and velocity. The processing system 290 can include a scanner controller 292 that can provide scanning signals to control operation of the optics 232, such as to control the motor 240 to cause the motor 240 to rotate the optics 232 to achieve a target scan pattern, such as a sawtooth scan pattern or step function scan pattern. The processing system 290 can include a Doppler compensator 294 that can determine the sign and size of a Doppler shift associated with processing the return beam 248 and a corrected range based thereon along with any other corrections. The processing system 290 can include a modulator controller 296 that can send one or more electrical signals to drive the modulator 214.

The processing system 290 can include or be communicatively coupled with a vehicle controller 298 to control operation of a vehicle for which the LIDAR system 200 is installed (e.g., to provide complete or semi-autonomous control of the vehicle). For example, the vehicle controller 298 can be implemented by at least one of the LIDAR system 200 or control circuitry of the vehicle. The vehicle controller 298 can control operation of the vehicle responsive to at least one of a range to the object or a velocity of the object determined by the processing system 290. For example, the vehicle controller 298 can transmit a control signal to at least one of a steering system or a braking system of the vehicle to control at least one of speed or direction of the vehicle.

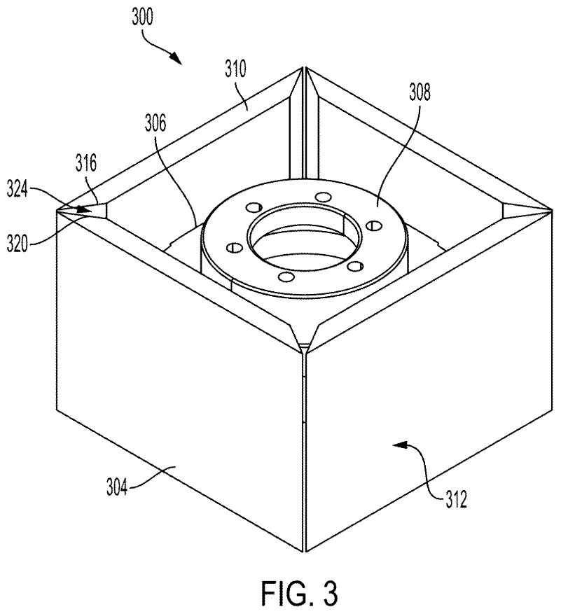

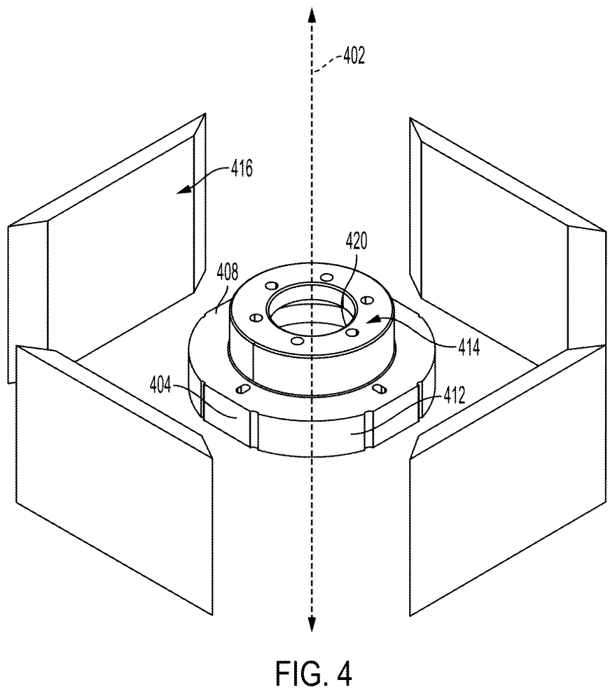

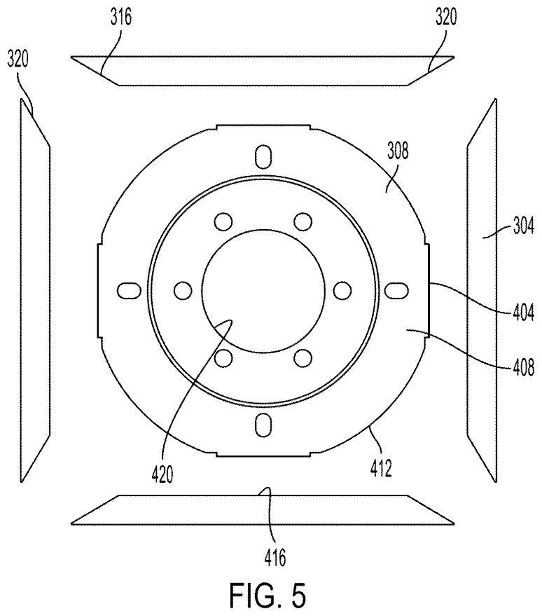

FIGS. 3-5 depict an example of optics 300 for a scanner. The scanner includes the optics 232 and the motor 240 as described with reference to FIG. 2. For example, the LIDAR system 200 can include one or more scanners to transmit and/or receive beams to and from objects in order to determine information such as range, velocity, or Doppler effects associated with the objects.

In some implementations, the optics 300 can be an assembled polygon that includes a plurality of mirrors 304 coupled with a frame 308. By assembling the optics 300 from separate components, rather than forming the scanner by machining a metal block, the optics 300 can be made to have improved optical and mechanical performance, including mirror form factor flexibility, low weight/inertia for a given mirror size, optical surface quality (e.g., lack of roughness), lower cost at volume, and robustness with respect to stresses such as thermal, shock, and vibration stresses. For example, by forming the optics 300 as an assembled device, the scanner can have about half the mass and inertia about axis 402 relative to a solid metal scanner having a similar or equal mirror size (e.g., a mass of 0.09 kg and an inertia about axis 402 of 5.2 e-5 kg m², as compared to a solid metal scanner having a mass of 0.2 kg and an inertia of 1.05 e-5 kg m²).

The mirrors 304 can be facets, and can have outward-facing surfaces 312 through which incoming beams are received and then reflected by the mirrors 304 to be outputted from the surfaces 312. The mirrors 304 can be reflective to light used for LIDAR applications (e.g., light received from the laser 204 via one or more components as depicted in FIG. 2 between the laser source 204 and the optics 232). For example, the mirrors 304 can be reflective to light having a wavelength greater than or equal to 1100 nm and less than or equal to 1800 nm, including light of about 1550 nm.

The optics 300 can include various numbers of mirrors 304. For example, the optics 300 can include greater than or equal to three and less than or equal to twelve mirrors 304. The mirrors 304 can be arranged around a perimeter 306 of the frame 308, such as to define a polygonal shape. Each mirror 304 can have a same shape as at least one other mirror 304, such as by having a rectangular shape with identical length and width, a circular or elliptical shape with identical perimeter, a convex or concave polygonal shape with identical numbers and lengths of sides, and various other such similar or identical shapes.

The mirrors 304 can be sized to extend outward from the frame 308; for example, a plane in which a surface 414 of the frame 308 lies can intersect at least one mirror 304 inward from an outer edge 310 of the at least one mirror 304. For example, the mirrors 304 can extend further than an extent of the frame 308 defined by the surface 414. The mirrors 304 can extend further above and further below the frame 308 in a frame of reference in which at least one of the axis 402 is parallel with gravity or the surface 414 is parallel with ground. The mirrors 304 can extend further than the surface 414 in a direction along the axis 402 (e.g., a projection of the mirrors 304 onto the axis 402 or a plane in which the axis 402 lies can be outward from the frame 308). This can allow the overall optical surface area of the mirrors 304 that can be used for reflecting incoming beams to be increased without increasing the size or weight of the frame 308, due to the assembled configuration and bonding of the mirrors 304 to the frame 308. As such, greater flexibility can be achieved for arranging various components of the LIDAR system 200 with respect to each other and with respect to the optics 300, which can enable the overall form factor to be decreased in size.

The mirrors 304 can include a glass material. For example, the mirrors 304 can include optical glass such as crown glass or flint glass. For example, the mirrors 304 can include K9 glass or BK7 glass, which can have improved thermal performance. As another example, the mirrors 304 can include glass of fused silica, which can operate effectively under conditions of UV and near infrared (NIR) light, with low coefficient of thermal expansion. The mirrors 304 can be formed by being cut from a larger glass panel, which can allow for more scalable production of the mirrors 304.

In some implementations, the mirrors 304 (e.g., surfaces 312) can be polished. Due to the use of glass for the mirrors 304 (e.g., rather than metal materials such as CNC machined and diamond turned aluminum), the mirrors 304 can be polished with greater flatness and lesser roughness, and as a result have improved optical properties, such as by reducing scattering of incoming light by the surfaces 312 (which can then be reflected off a backing of the mirrors 304 and then outputted from the surfaces 312, again with reduced scattering). For example, in an example test of scattering by glass mirrors 304 as compared with diamond turned aluminum (each coated with unprotected gold), the polished glass of the mirrors 304 was found to have relative scattering of 0.80 dB, while the metal (diamond turned aluminum) was found to have relative scattering of 6.14 dB. As such, the glass mirrors 304 can have reduced likelihood of scattering of light beams within the structures defining the roughness of the surfaces 312, which can address issues such as Doppler components being contributed to the beam's signal by the scattering. In turn, signal processing computational demands can be reduced, as signal processing needed to remove the Doppler components can be reduced or eliminated. In some implementations, the mirrors 304 can be coated with a coating. For example, gold (e.g., unprotected gold), can be used as a coating material. However, the coating material is not limited to gold. Instead, any suitable reflective material can be used as a coating material.

As depicted in FIGS. 3-5, the mirrors 304 can have rectangular shapes. The mirrors 304 can have various shapes or form factors, including concave or convex shapes, based on the shape of the glass panel from which the mirrors 304 are made, as well as how the mirrors 304 are cut or otherwise extracted from the glass panel. For example, the glass panel can be curved, so that the mirrors 304 are formed to be curved (e.g., concave or convex); the shape of the mirrors 304 as extracted from the glass panel can also be controlled to select a shape of the mirrors 304, such as to provide the mirrors 304 with rounded edges 310. As such, the mirrors 304 can be made to direct received beams in various directions or angles depending on the shape of the mirrors 304. The mirrors 304 can be made so that the surfaces 312 have relatively greater surface area than if denser metal were used for the mirrors 304 without increasing the weight/inertia of the mirrors 304 (or the size can be kept similar while reducing the weight/inertia). Moreover, by using glass to form the mirrors 304, the shapes or form factors of the mirrors 304 can more readily be selected and implemented for particular applications as compared to solid metal scanners.

In some implementations, each mirror 304 can extend from a first edge 316 to a second edge 320, and can be arranged so that there is a gap 324 between respective edges 316, 320 of adjacent mirrors 304. The gaps 324 can allow for expansion or other movement or change in shape of the mirrors 304, such as due to thermal or vibration effects. The edges 316, 320 can be angled, such that the gaps 324 decrease in size in a direction away from the axis 402 (while some gap 324 is still retained where edges 316, 320 meet surfaces 312). In some other implementations, the mirrors 304 can be arranged without any gap between respective edges 320 of adjacent mirrors 304.

The frame 308 can be made from a metal material, such as to be formed as a metal block. For example, the frame 308 can be made from aluminum. Using aluminum for the frame 308 can enable the frame 308 to be relatively lightweight and easy to manufacture. The frame 308 or portions thereof can be made from various materials, such as plastic or composite materials, that have sufficient rigidity or other material or structural properties across temperatures of operation of LIDAR system to allow for efficient force transfer from the frame 308 to the mirrors 304.

Each mirror 304 can be bonded at a respective bond surface 404 of the frame 308. The bond surfaces 404 can be positioned on or define the perimeter 306 of the frame 308. For example, the frame 308 can include a wall 408 (e.g., perimeter wall) that is oriented traverse to an axis 402 of the frame 308. The bond surfaces 404 can be defined on the wall 408. As depicted in FIG. 3, the bond surfaces 404 can extend over respective portions of the wall 408, such that there are portions 412 of the wall 408 between the bond surfaces 404 on either side of the bond surfaces 404. The portions 412 can be spaced from inner surfaces 416 of the mirrors 304 (as compared with solid form scanners, in which no spaces or gaps would be presented between the reflective surfaces and the inner portions of the scanner), the spacing defined in a plane extending through the wall 408 and perpendicular to the axis 402. The bond surfaces 404 can be flat, while the portions 412 can be curved or otherwise shaped to extend inward from the inner surfaces 416. A central portion of the inner surfaces 416 can be coupled with the bond surfaces 404 (e.g., the bond surfaces 404 can be centrally located on inner surfaces 416), which can minimize radial effects on the mirrors 304 or other components during thermal expansion and contraction due to changes in temperature.

An adhesive (e.g., bonding material) can be provided on the bond surfaces 404 (e.g., placed on a central portion of the inner surfaces 416 and/or bond surfaces 404) to attach the mirrors 304 to the bond surfaces 404, which can enable symmetric thermal expansion (e.g., with relatively low thermally developed expansion stresses). For example, an epoxy, such as a dispensed epoxy, can be used to attach the mirrors 304 to the bond surfaces 404. At least one of the material properties of the adhesive and the surface area of the bond surfaces 404 can be selected so that an attachment force between the bond surfaces 404 and the mirrors 304 is greater than an apparent (e.g., centrifugal) force resulting from the rotation of the optics 300 (e.g., rotation of the scanner of the optics 300) that would drive the mirrors 304 away from the bond surfaces 404 during operation of the optics 300 due to rotation of the optics 300 about the axis 402. For example, the attachment force can be greater than the centrifugal force at a maximum expected rotation rate of the scanner by at least a threshold. The adhesive can be selected to have a coefficient of thermal expansion that is similar or about equal to that of the mirrors 304, which can improve the performance of the optics 300 with respect to thermal expansion or contraction.

The frame 308 can include a shaft receiver 420 inward from the wall 408. The shaft receiver 420 can be a channel or other opening to allow a shaft (e.g., shaft or axle coupled with the motor 240 described with reference to FIG. 2) to engage the frame 308, so that the motor 240 can rotate the shaft rotate the frame 308 about the axis 402. The motor 240 can be coupled with the frame 308 using various shafts, gears, or other couplings to cause rotation of the frame 308 about the axis 402. The axis 402 can be defined to at least one of extend through the shaft receiver 420, coincide with an axis of rotation of the motor 240, or coincide with an axis of rotation of the shaft (e.g., the shaft may rotate about an axis offset from the motor 240 due to the use of gears or other assemblies).

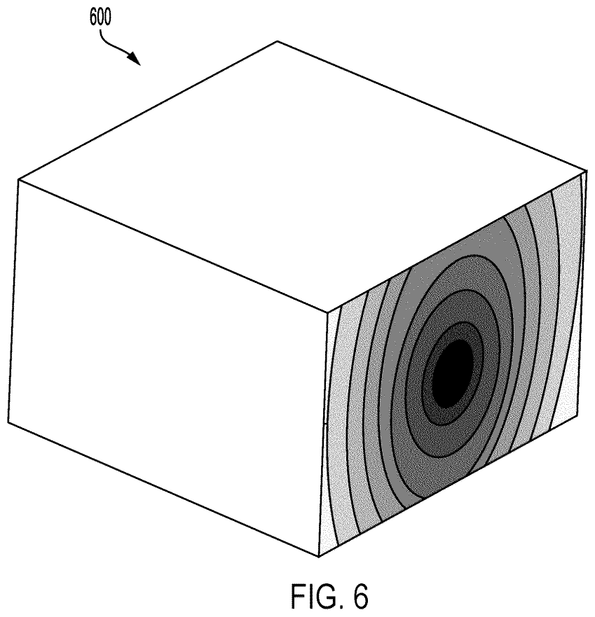

FIGS. 6-8 depicts charts of studies of the performance of the mirrors 304 during operation and with respect to various environmental conditions, such as thermal, shock, and vibration conditions. As shown by FIGS. 6-8, the optics 300 can be designed as described herein to have minimal impact on optical surface quality under a wide temperature range, and low weight/inertia to have robustness advantages under shock/vibration (e.g., due to operation of the motor 240).

FIG. 6 depicts a chart 600 of distortion of the mirrors 304 with respect to thermal loading under the thermal stresses that can be expected for operation of a LIDAR system for automotive applications. For example, at least one mirror 304 can have a distortion out of a plane of the mirror 304 no greater than about 200 nm, such as from 0 nm to about 200 nm. As depicted in FIG. 6, the mirrors 304 were found to have distortion (e.g., translation out of a plane of the surfaces 312) ranging from 101 nm at a temperature of negative 20 degrees Celsius to 67 nanometers at a temperature of 50 degrees Celsius. Various features of the optics 300 described herein, such as centrally located coupling between the mirrors 304 and bond surfaces 404 to reduce or minimize bond-influenced stresses and distortions, can enable this distortion performance.

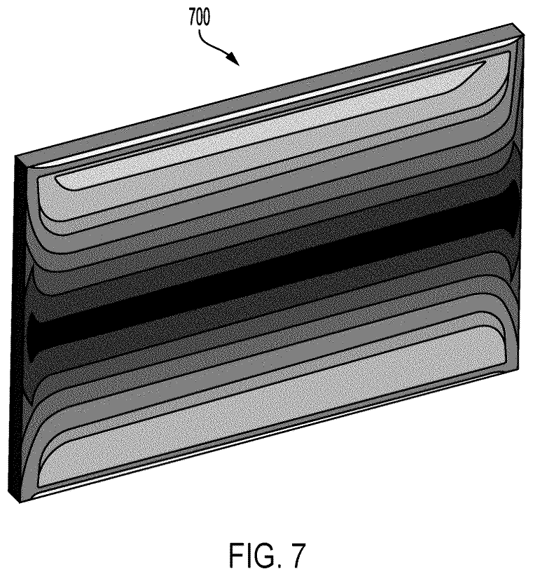

FIG. 7 depicts a chart 700 of bond patch peel load. The bond patch peel load can correspond to a vertical load resulting from shock stresses on the optics 300, such as shock transmitted from a vehicle to the optics 300 (e.g., through the motor 240). The optics 300 can be configured as described herein, such as based on the weight of the mirrors 304 and the bonding between the mirrors 304 and frame 308, such that in response to a 50 G vertical load, the mirrors 304 are subject to a 0.16 MPa bond peeling stress (which can correspond to a stress of 16 N/m given the size of the mirrors 304).

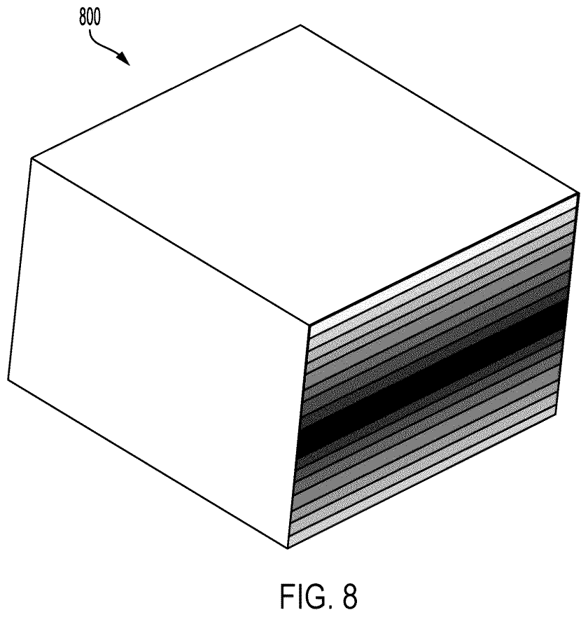

FIG. 8 depicts a chart 800 of angular displacement of the mirror 304 with respect to a vibration condition. As depicted in FIG. 8, in response to a vibration of 3 GRMS (root mean square acceleration associated with random vibration), the mirror 304 can have a 1.3 nm rigid body tilt, or 37.1e-9 radian angular displacement at a vibration of 667 Hz.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A light detection and ranging (LIDAR) sensor system, comprising:
a laser source configured to generate a beam; and
a polygon scanner, comprising:
a frame; and
a plurality of mirrors coupled to the frame by an adhesive, the adhesive having a coefficient of thermal expansion about equal to that of the plurality of mirrors, the plurality of mirrors arranged so that there is a gap between respective edges of adjacent mirrors, each mirror comprising a glass material.

2. The LIDAR sensor system of claim 1, wherein each mirror of the plurality of mirrors extends above and below the frame.

3. The LIDAR sensor system of claim 1, wherein each mirror of the plurality of mirrors is bonded to a central portion of a corresponding surface of the frame and is spaced from an outer portion of the corresponding surface.

4. The LIDAR sensor system of claim 1, wherein the frame is made of metal.

5. The LIDAR sensor system of claim 1, wherein the plurality of mirrors are reflective to light having a wavelength greater than or equal to 1100 nm and less than or equal to 1800 nm.

6. The LIDAR sensor system of claim 1, wherein the plurality of mirrors comprise greater than or equal to three and less than or equal to twelve mirrors.

7. The LIDAR sensor system of claim 1, wherein the plurality of mirrors have a concave shape or a convex shape.

8. The LIDAR sensor system of claim 1, wherein the plurality of mirrors are made of polished glass coated with a coating material.

9. The LIDAR sensor system of claim 1, wherein the adhesive comprises an epoxy.

10. The LIDAR sensor system of claim 1, wherein the adhesive comprises a dispensed epoxy such that an attachment force between the frame and the plurality of mirrors is greater than a centrifugal force on the plurality of mirrors at an expected maximum rotation rate of the polygon scanner.

11. The LIDAR sensor system of claim 1, further comprising a motor coupled with a shaft, wherein the frame comprises a channel to receive the shaft.

12. The LIDAR sensor system of claim 1, wherein a distortion of at least one mirror of the plurality of mirror relative to a plane of the at least one mirror is from 0 nanometers (nm) to less than about 200 nm over a temperature range from about negative twenty degrees Celsius to about 50 degrees Celsius.

13. An autonomous vehicle control system, comprising:
a laser source configured to generate a first beam;
a polygon scanner, comprising:
a frame; and
a plurality of mirrors coupled to the frame by an adhesive, the adhesive having a coefficient of thermal expansion about equal to that of the plurality of mirrors, the plurality of mirrors arranged so that there is a gap between respective edges of adjacent mirrors, each mirror comprising a glass material, the polygon scanner configured to reflect the first beam to output a second beam; and
one or more processors configured to:
determine at least one of a range to an object or a velocity of the object using a third beam received from reflection of the second beam by the object; and
control operation of an autonomous vehicle based on the at least one of the range or the velocity.

14. The autonomous vehicle control system of claim 13, further comprising a modulator configured to receive the first beam and to modulate at least one of a phase or a frequency of the first beam to output a modulated beam to the polygon scanner.

15. The autonomous vehicle control system of claim 13, further comprising a motor configured to rotate the polygon scanner according to a scan pattern for the second beam.

16. The autonomous vehicle control system of claim 13, wherein the one or more processors are configured to transmit a control signal to at least one of a steering system of the autonomous vehicle or a braking system of the autonomous vehicle to control operation of the autonomous vehicle.

17. The autonomous vehicle control system of claim 13, wherein the frame comprises metal, and wherein the adhesive comprises a dispensed epoxy such that an attachment force between the frame and the plurality of mirrors is greater than a centrifugal force on the plurality of mirrors at an expected maximum rotation rate of the polygon scanner.

18. An autonomous vehicle, comprising:
a LIDAR system, comprising:
a laser source configured to generate a first beam; and
a polygon scanner comprising a frame and a plurality of mirrors coupled to the frame, each mirror comprising a glass material and extending above and below the frame, the polygon scanner configured to reflect the first beam to output a second beam;
a steering system;
a braking system; and
a vehicle controller comprising one or more processors configured to:
determine at least one of a range to an object or a velocity of the object using a third beam received from reflection of the second beam by the object; and
control operation of the at least one of the steering system and the braking system based on the at least one of the range or the velocity.

19. The autonomous vehicle of claim 18, wherein the vehicle controller is configured to control at least one of a speed of the autonomous vehicle or a direction of the autonomous vehicle based on the at least one of the range or the velocity.

20. The autonomous vehicle of claim 18, wherein each mirror of the plurality of mirrors is bonded to a central portion of the frame by an epoxy and is spaced from an outer portion of the corresponding surface.
